(19) United States
(12) Patent Application Publication
(10) Pub. No.: US 2021/0109535 A1
(43) Pub. Date: Apr. 15, 2021

(54) Systems And Methods For Controlling An Unmanned Self-Powered Follow Vehicle Following A Lead Vehicle With Independent Hazard Avoidance By The Follow Vehicle

(71) Applicant: Kyle Tansey, Calgary (CA)

(72) Inventor: Kyle Tansey, Calgary (CA)

(21) Appl. No.: 16/600,638

(22) Filed: Oct. 14, 2019

(51) Int. Cl. G05D 1/02; G05D 1/00; B60W 10/04; B60W 10/20; B60W 30/09

(52) U.S. Cl. CPC G05D 1/0214; B60W 2550/12; B60W 10/04; B60W 10/20; B60W 30/09; G05D 1/0257; G05D 1/0255; G05D 1/0231; G05D 1/0242; G05D 1/0278; B60W 2550/10; B60W 2550/408; B60W 2550/406; B60W 2550/14; G05D 1/0011

(57) ABSTRACT

Systems and methods disclosed relate to autonomous control of an unmanned, self-powered vehicle following a lead vehicle. A lead vehicle is manually driven by a driver along a path and operational data indicating operation of the lead vehicle is received by the follow vehicle. The follow vehicle uses this data along with other data collected by sensors on the follow vehicle to determine the best path to follow behind the lead vehicle. The follow vehicle can independently identify a hazard and automatically determine and execute vehicle control instructions to avoid hitting the hazard.

### FIELD OF THE INVENTION

The present disclosure relates to systems and methods of virtual towing of unmanned, self-powered vehicles.

### BACKGROUND OF THE INVENTION

Partially and fully automated or autonomous vehicles have been proposed. In a great extent, these vehicles are desirable to increase efficiency and safety in traffic when transporting goods or people. For this reason, a myriad of systems and methods exist, albeit to date that have not been largely adopted in practice, for semi-autonomous or fully autonomous vehicle control.

For example, US Published Application Number 2017/0166207, the entirety of which is incorporated herein by reference, describes a method for automatically controlling a following vehicle. A leading vehicle is guided along an actual trajectory, and a desired trajectory is produced for the following vehicle. The actual trajectory of the leading vehicle is captured by the following vehicle, and a trajectory similarity is determined by comparing the captured actual trajectory of the leading vehicle and the produced desired trajectory of the following vehicle. Automatic control of the following vehicle along the desired trajectory is activated if the trajectory similarity exceeds a particular value.

U.S. Pat. No. 10,007,271, the entirety of which is incorporated herein by reference, describes a follow vehicle having driving controls for use by humans that may be equipped with a wireless transceiver, controller, sensors, and interfaces for use with control systems such that the follow vehicle may be caused to follow the lead vehicle without human interaction with the follow vehicle. The follow vehicle may wirelessly receive information from the lead vehicle regarding position, movement, acceleration or deceleration, steering, or other information relevant to following the lead vehicle. The follow vehicle may include sensors for sensing the position, movement, acceleration, deceleration, steering, or other properties of the lead vehicle. The lead vehicle may be equipped with RF transmitters that provide indicators to the follow vehicle, such that the sensors can more readily sense the lead vehicle. Multiple follow vehicles may be wirelessly linked to form a train that is not mechanically linked.

US Published Application Number 2019/0049991, the entirety of which is incorporated herein by reference, describes a virtual towing system for an automated vehicle includes a disabled-vehicle equipped with a first-transceiver that broadcasts a tow-request when perception-sensors of the disabled-vehicle have malfunctioned. The system also includes a tow-vehicle equipped with a second-transceiver that transmits guidance-data to the first-transceiver in response to the tow-request, whereby the disabled-vehicle operates in accordance with the guidance-data.

And, US Published Application Number 2016/0231746, the entirety of which is incorporated herein by reference, describes systems and methods for operating an automated vehicle such as an autonomous vehicle may include an autonomous guidance system, a method of automatically controlling and autonomous vehicle based on electronic messages from roadside infrastructure or other-vehicles, a method of automatically controlling an autonomous vehicle based on cellular telephone location information, pulsed LED vehicle-to-vehicle (V2V) communication system, a method and apparatus for controlling an autonomous vehicle, an autonomous vehicle with unobtrusive sensors, and adaptive cruise control integrated with a lane keeping assist system. These systems and methods may use information from radar, lidar, a camera or vision/image devices, ultrasonic sensors, and digital map data to determine a route or roadway position and provide for steering, braking, and acceleration control of a host vehicle.

Missing from the foregoing described systems and methods, and other now existing systems and methods, is the automatic control of a completely unmanned, self-powered road vehicle operating in virtual towing behind a lead vehicle, wherein the automatic control allows for the unmanned, follow vehicle to independently identify obstacles or hazards and take evasive maneuvers to avoid them.

### SUMMARY OF THE INVENTION

The disclosure that follows describes systems and methods for the virtual towing of unmanned, self-powered vehicles, including the ability of the unmanned, virtually towed or follow vehicle to independently identify obstacles or hazards and take evasive maneuvers to avoid them.

In embodiments, the disclosure describes systems and methods of controlling a self-powered and articulated trailer vehicle in a semi-autonomous state. The trailing vehicle can follow and mimic the maneuvers of a lead vehicle while independently adjusting and correcting for speed, direction, operating conditions and hazards.

In embodiments, the disclosure describes systems and methods including two constant modes of controlling and manipulating the trailer vehicle. First, input information from the lead vehicle including acceleration, braking, changes of direction and other hazard or condition related information is wirelessly sent from the lead vehicle to the trailer vehicle, continuously. This may be through a computer-based data port of the lead vehicle, or through a purpose-built attachment, for example motorcycles which monitor roll.

Second, the trailer vehicle will utilize onboard sensors including but not limited to image sensors, radar, lidar, temperature, proximity, infrared and accelerometers. This secondary data is combined with input data above and processed by a trailer-mounted ECU following the three stages: sense (aggregate data), evaluate (consider input instruction and surrounding area) and execute (prioritize output, complete necessary operation). This process repeats in perpetuity hundreds of times per second allowing fluid uninterrupted travel with sudden emergency counter-procedures. Secondary data may also include pre-existing data sets such as maps, weather information and externally-streamed data (prioritizing speed/efficiency based on elevation and future conditions).

Where the trailering vehicle encounters a hazard such as another vehicle cutting into its lane of travel it will prioritize secondary sensor data to maneuver to avoid the hazard. This may involve braking, steering or accelerating. As the wireless data connection will remain connected for distances of at least 100 metres, the trailer will be able to recover and continue in tandem with the lead vehicle following intervening events.

Finally, output data from the trailer device including onboard cameras and operating conditions such as fuel, power, and temperature are wirelessly streamed to a mobile device such as a mobile phone, or the lead vehicle infotainment system/screen. Where the trailering vehicle encounters an unrecoverable risk or error (such as where the lead vehicle drives off a cliff) it will maneuver to a safe area and park independently. Said parking and low speed maneuvers will also be possible via a device connection such as a phone app.

The trailering vehicle has the capability to be small or large, with varying amounts of power and weight capabilities. It may be combustion-powered, full electric or other. It may be used for carriage of goods or specified purpose vehicles such as camping trailers, power generators or modular construction. Given the wireless mode of connection, more than one trailering vehicle may be attached in an unlimited ‘daisy chain’ of communication, each following the lead vehicle while independently monitoring and acting on secondary input data.

As a non-limiting example, a convoy of numerous cargo trailers following a single ‘trucker’, in a far more efficient and agile lead vehicle not requiring any towing capacity. Or a family going on holiday with a camper, boat and rec equipment on a flatbed led by a small economy vehicle.

In general, in one aspect, a method for controlling an unmanned, self-powered follow vehicle following a lead vehicle is provided. The method comprising the following steps:
receiving, by the follow vehicle comprising a processor, guidance information wirelessly transmitted to the follow vehicle from the lead vehicle, wherein the guidance information reflects current lead vehicle driving operation being performed by the lead vehicle;
determining, by the follow vehicle, a trajectory target location at least based in part on the guidance information received from the lead vehicle;
determining, by the follow vehicle, follow vehicle control instructions to control the follow vehicle driving operations to cause the follow vehicle to move to the trajectory target location;
comparing, by the follow vehicle, the follow vehicle control instructions with follow vehicle operational data to determine a conflict threshold between the follow vehicle control instructions and the follow vehicle operational data; and
activating, by the follow vehicle, automatic control of the follow vehicle to the trajectory target location using the follow vehicle control instructions in response to the determined conflict threshold being below a setpoint that indicates the follow vehicle will not collide with a hazard in route to the trajectory target location.

In another aspect, the method can include the additional steps of:
identifying, by the follow vehicle, a hazard at least in part by using the follow vehicle operational data in response to the determined conflict threshold being above a setpoint that indicates the follow vehicle will collide with a hazard in route to the trajectory target location;
determining, by the follow vehicle, an avoidance trajectory target location based at least in part on the identified hazard, the follow vehicle operational data, and the trajectory target location;
determining, by the follow vehicle, follow vehicle avoidance control instructions to control the follow vehicle driving operations to cause the follow vehicle to move to the avoidance trajectory target location;
comparing, by the follow vehicle, the follow vehicle avoidance control instructions with follow vehicle operational data to determine a second conflict threshold between the follow vehicle avoidance control instructions and the follow vehicle operational data; and
activating, by the follow vehicle, automatic control of the follow vehicle to the avoidance trajectory target location using the follow vehicle avoidance control instructions in response to the determined second conflict threshold being below a setpoint that indicates the follow vehicle will not collide with the identified hazard or another hazard in route to the avoidance trajectory target location.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 illustrates a block diagram of major system components according to an embodiment of the invention;

FIG. 2 illustrates a flow chart of steps that may be taken according to an embodiment of the invention;

FIG. 3 illustrates a graph shown the relationship between vehicle speed and target delay;

FIG. 4 illustrates a block diagram of two vehicles according to an embodiment of the invention;

FIG. 5 illustrates a block diagram of two vehicles according to an embodiment of the invention;

FIGS. 6a and 6b illustrate a block diagrams of two vehicles according to an embodiment of the invention;

FIG. 7 illustrates a block diagram of two vehicles according to an embodiment of the invention;

FIG. 8 illustrates a block diagram of a follow vehicle according to an embodiment of the invention; and

FIGS. 9a, 9b, and 9c illustrate a graphs shown the relationship between a motor cycle lead vehicle's speed and lean in relation to a desired follow vehicle speed and target path.

### DETAILED DESCRIPTION OF THE INVENTION

Various embodiments are now described with reference to the drawings. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

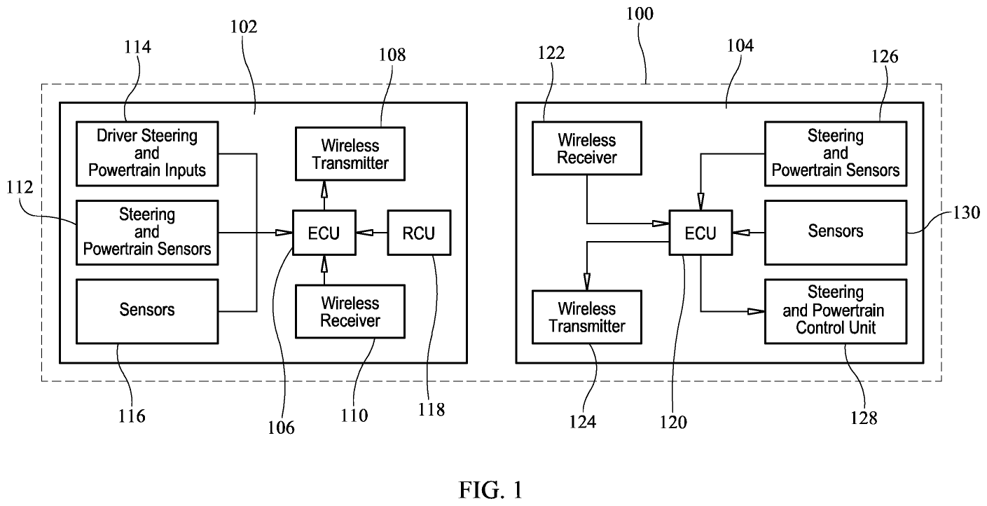

Turning initially to FIG. 1, there is shown a block diagram of a system 100 in accordance with an embodiment of the invention. System 100 may be used in implementing the systems and methods disclosed herein. A shown, system 100 may include a lead vehicle 102 and one more follow vehicles 104.

An important aspect of system 100 and related methods disclosed herein is the lead vehicle 102 does not have be a large vehicle that is traditionally used for towing cargo, such as a tractor trailer, for example. Rather the lead vehicle 104 may be a smaller vehicle that is more economical to operate. Further yet, the lead vehicle 104 may be a recreational vehicle or motor home. The lead vehicle 104 may be any road vehicle as desired. Another important aspect of system 100 and the related methods disclosed herein is the one or more follow vehicles 104 are self-powered and are unmanned, that is the follow vehicles do not have a driver.

With continued reference to FIG. 1, the lead vehicle 102 may include many components to implement the systems and methods described herein. For example, the lead vehicle 102 may include an electronic control unit 106, a wireless transmitter 108, a wireless receiver 110, steering and powertrain sensors 112, driver steering and powertrain inputs 114, sensors 116, and a remote control unit 118. The one or more follow vehicles 104 may include many components to implement the systems and methods described herein. For example, a follow vehicle may include an electronic control unit 120, a wireless receiver 122, a wireless transmitter 124, steering and powertrain sensors 126, a steering and powertrain controller 128, and sensors 130.

The various components may be similar or different for a lead vehicle and a follow vehicle. For example, in a lead vehicle it may be more advantageous to have certain rear-facing sensors for determining the position or other attributes of the follow vehicle, while in a follow vehicle it may be more advantageous to have certain forward-facing sensors for determining the position or other attributes of the lead vehicle.

Computing units 106 and 120 may comprise one or more processors, memory, input and output capabilities, battery or other power sources, and requisite electronics and circuitry for the purposes to be accomplished. Steering and powertrain sensors 112 and 126 may include sensors that sense steering inputs, lateral movement, speed, acceleration, deceleration, throttle position, brake position, gear engagement, engine temperature, fuel level, wheel alignment, steering wheel position, and/or numerous other types of information and generate lateral motion data and forward motion data among other types of data. Sensors 112 and 126 may be implemented by attaching physical sensors to the lead vehicle 102 or follow vehicle 104 or by interfacing electronically or mechanically with sensors that are already present in vehicle 102 and/or 104. The steering and powertrain control unit 128 in the follow car 104 is configured to manipulate the vehicle's steering and powertrain components using electric control instructions as described herein in further detail.

Wireless transmitters 108 and 124 and wireless receiver 110 and 122 may be separate or integrated into a single unit, respectively. The wireless transmitters may be RF transmitters that transmit according to cellular transmission standards, 802.11 standards, citizen's band, audio, optical, or other known transmission methods. In some embodiments the transmitters and receivers may be line-of-sight devices, including laser devices. In other embodiments, it may be desirable to enable longer distance wireless communications. One of ordinary skill in the art will be able to pick or design a wireless transmitter and receiver that have sufficient range, reliability, and transmission rates for the methods and systems set forth herein.

Driver steering and powertrain inputs 114 are provided by a human operator in the lead vehicle 102. In the case of a convoy embodiment where multiple vehicles are following a lead vehicle 102, each of the follow vehicles may receive driver steering and powertrain inputs from a steering and powertrain control unit. The driver steering and powertrain inputs may be sensed by the steering and powertrain sensors 112 or 126. Or the inputs may be sensed by dedicated sensors and relayed to the electronic control unit 106 or 120.

Sensors 116 and 130 may include many types of sensors related to positioning, movement, computer vision, etc. that may be useful in providing systems and methods by which one vehicle may follow another without human operation of the follow vehicle. For example, sensors 116 or 130 may include radar, lidar, sonar, optical distance, alignment, laser, GPS, Doppler, infrared, ultraviolet, audio, various RF, acceleration, deceleration, engine heat, gyroscopic, magnetic, microphone, and other sensors both discussed herein and not discussed herein but known in the art.

In lead vehicle 102, sensors 116, steering and powertrain inputs 114, and steering and powertrain sensors 112 may provide various inputs into electronic computing unit 106, along with received information from receiver 110. Computing unit 106 may process some or all the received information and determine which information to send to vehicle 104 or another vehicle via wireless transmitter 108. Wireless transmitter 108 then transmits a transmission intended for receipt by at least wireless receiver 122. Depending on the types of sensors 108 or transmitters included in vehicle 102, sensors 108 or transmitters may provide additional data to sensors 130 through direct transmission.

In the follow vehicle 104, information sensed by sensors 130, inputs from steering and powertrain sensors 126, feedback from the steering and powertrain control unit 128 and operational information received by wireless receiver 122 may be transmitted to electronic computing unit 120. Electronic computing unit 120 may process some or all the received information and determine which commands to output to the steering and powertrain control unit 128 in the form of control data to control the vehicle 104. Computing unit 124 may also determine which commands or information to send to vehicle 102 or another vehicle via wireless transmitter 124. In embodiments, electronic computing unit 120 processes information (data) received from at least sensors 130 to independently and automatically determine if the vehicle may encounter a hazard along its project path or route. If a hazard is detected, electronic computing unit 120 may operate to provide instructions to the steering and powertrain control unit 128 to operate the vehicle to avoid the hazard.

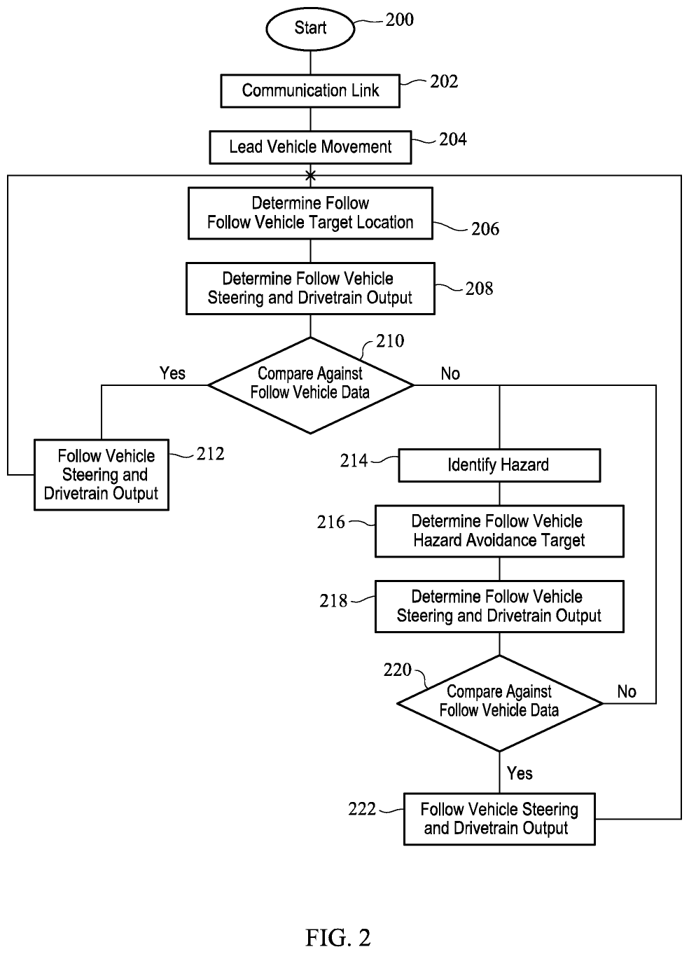

In FIG. 2, a flowchart for a method according to an embodiment of the invention is illustrated. It will be recognized that this flowchart is provided by way of example only and sets forth basic steps that may be used in implementing the invention, but does not set forth every detailed step that may be used in the invention to achieve virtual towing of an unmanned, selfpowered vehicle with hazard detecting and avoidance.

In step 200, the method is started. In step 202, a wireless connection is established between a lead vehicle 102 and a follow vehicle 104. At step 202, if multiple vehicles will be convoying together, it is desirable to establish a wireless communication link, either direct or indirect, between lead vehicle 104 and each of the follow vehicles. At step 204, lead vehicle 102 begins movement and starts transmitting guidance information to the follow vehicles, which is received by the follow vehicles. The guidance information reflects current lead vehicle driving operation being performed by the lead vehicle.

At step 206, the follow vehicle electronic computation unit 120 operates to determine a trajectory target location of the follow vehicle at least based in part on the guidance information received from the lead vehicle 104. At step 208, the follow vehicle electronic computation unit 120 operates to determine follow vehicle control instructions to control the follow vehicle driving operations to cause the follow vehicle to move to the trajectory target location. In this step, the electronic computation unit 120 may use operational information from sensors 130, information from steering and powertrain sensors 126, and feedback from the steering and powertrain control unit 128 to determine vehicle control instructions to move the follow vehicle to the trajectory target location.

At step 210, the follow vehicle electronic computation unit 120 audits or compares the vehicle control instructions created in step 208 against vehicle operational data received by sensors 130 to determine whether the follow vehicle is likely to encounter a hazard in route to the trajectory target location by following the vehicle control instructions. The hazard can be anything that would be problematic to operation of the follow vehicle, including, but not limited to another vehicle, an object in the road, a road curb or shoulder, a pedestrian, a pothole, and lane markers, for example.

A certain conflict threshold is set for a minimum level of conflict between the vehicle control instructions and the data from sensors 130 to indicate the presence of a hazard. In certain embodiments, if data from one or more noncritical sensors is the only conflicting data, this data may be ignored in determining the conflict threshold.

If, in step 210, a hazard is not identified because the determined conflict threshold is below the minimum value that indicates hazard presence, the computation unit sends the vehicle control instructions to the steering and powertrain controller 128 to operate the vehicle to reach the trajectory target location. If, however, at step 210, the determined conflict threshold is above the minimum value, indicated a hazard, the follow vehicle computation unit 120 utilizes data from sensors 130 to determine a hazard avoidance trajectory target with the purpose of avoiding the identified hazard. Then, in step 218, the follow vehicle computation unit 120 determines a follow vehicle avoidance control instruction to control the follow vehicle driving operations to cause the follow vehicle to move to the avoidance trajectory target location.

In step 220, the follow vehicle computation unit 120 audits or compares the follow vehicle avoidance control instructions with follow vehicle operational data received from at least sensors 130 to determine a second conflict threshold between the follow vehicle avoidance control instructions and the follow vehicle operational data. If the second conflict threshold is below a level that indicates the follow vehicle will not encounter the hazard in route to the avoidance trajectory target location, the method proceeds to step 222. However, if the second conflict threshold is above a level that indicates the follow vehicle will encounter the hazard in route to the avoidance trajectory target location, the method returns to step 214.

In step 222, the computation unit 120 sends the vehicle control instructions to the steering and powertrain controller 128 to operate the vehicle to reach the avoidance trajectory target location. Then the method returns to step 206. This method repeats several hundred times a second to ensure a smooth operation of the follow vehicle and hazard avoidance.

In embodiments, if it is determine the follow vehicle cannot avoid a hazard, the electronic computation unit 120 determine halt operation instructions to the steering and powertrain control unit 128 to cause the follow vehicle to brake and stop in response to the determined second conflict threshold remaining above the setpoint that indicates the follow vehicle will collide with a hazard in route to the avoidance trajectory target location.

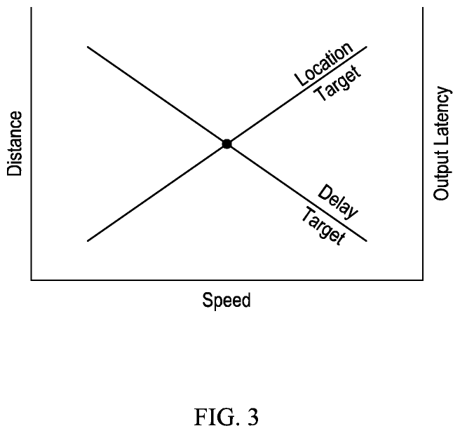

With reference to FIG. 3, in embodiments calculation of the follow vehicle trajectory target location will be dependent on the speed and direction of the lead vehicle. For the follow vehicle to calculate the appropriate target location of travel it may determine the intended location considering output delay to account for speed. The slower the speed of travel by the lead vehicle, the greater the delay in reaching the intended trailing location by the follow vehicle. As the lead vehicle reduces speed the target delay increases. As speed increases, latency will decrease. It is also important to increase the distance between the lead vehicle and the follow vehicle for higher speeds to provide a safe follow distance in case of emergency maneuvers and braking. This target distance will increase and decrease linearly with speed and be matched with the appropriate output delay, producing the target output.

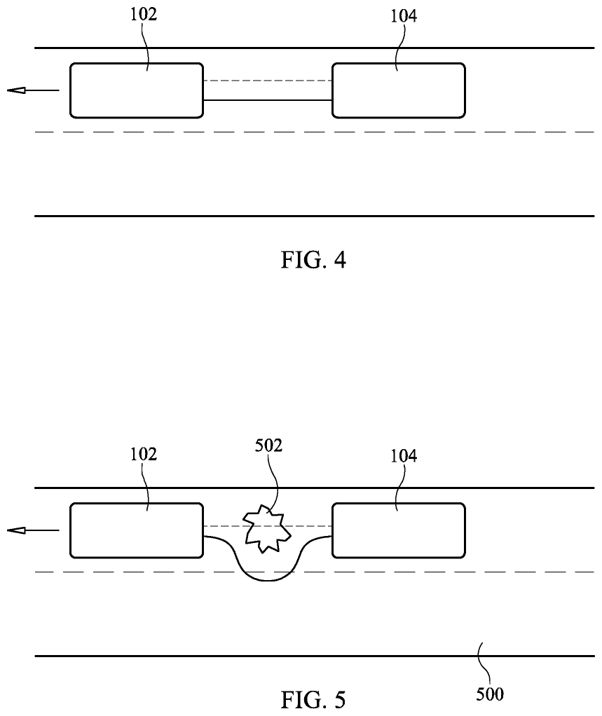

In FIG. 4, a partial block diagram of a pair of vehicles implementing an embodiment of the invention is depicted. Lead vehicle 102 and follow vehicle 104 are depicted on surface 400. Lead vehicle 102 is depicted in front of follow vehicle 104. While not shown here, lead vehicle 102 and follow vehicle 104 may include all the components as described in connection with FIG. 1. Here, the lead vehicle 102 and the follow vehicle 104 are operating with the follow vehicle following the lead vehicle without any hazards that would cause evasive maneuvering by either of the vehicles. Particularly, the dashed line indicates the trajectory target location of the follow vehicle, and the solid line indicates the actual path the follow vehicle follows.

In FIG. 5, a partial block diagram of a pair of vehicles implementing an embodiment of the invention is depicted. Lead vehicle 102 and follow vehicle 104 are depicted on surface 500. Lead vehicle 102 is depicted in front of follow vehicle 104. While not shown here, lead vehicle 102 and follow vehicle 104 may include all the components as described in connection with FIG. 1. Here, a hazard 502 has become between the lead vehicle 102 and the follow vehicle 104. The dash line indicates the trajectory target location of the follow vehicle 104. However, follow vehicle 104 identify the hazard in its path, and the solid line indicates the avoidance trajectory target location that the follow vehicle follows to avoid the hazard.

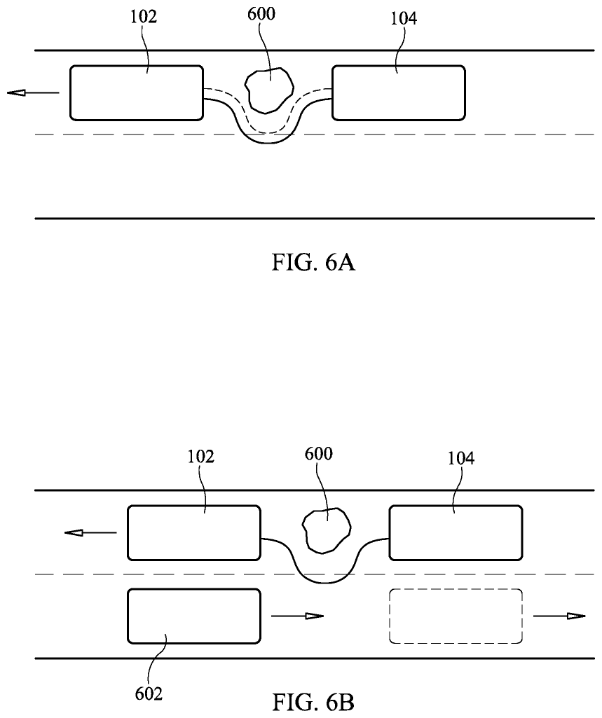

In FIGS. 6a and 6b, partial block diagrams of a pair of vehicles implementing an embodiment of the invention is depicted where the lead vehicle takes an evasive maneuver to avoid a first hazard 600 and second hazard 602 comes into play following the lead vehicle's evasive maneuver that prevents the follow vehicle from taking the same evasive maneuver of the lead vehicle. Lead vehicle 102 and follow vehicle 104 are depicted on the road surface. Lead vehicle 102 is depicted in front of follow vehicle 104. While not shown here, lead vehicle 102 and follow vehicle 104 may include all the components as described in connection with FIG. 1. Here, as shown in FIG. 6a, the lead vehicle 102 performed an evasive maneuver to avoid hazard 600. The dash line indicates the trajectory target location of the follow vehicle 104 to perform an evasive maneuver to also avoid the hazard 600. However, as shown in FIG. 6b, before follow vehicle 104 can travel the dashed trajectory target location, the follow vehicle identifies an oncoming vehicle 602 as a hazard preventing the follow vehicle from moving along the dashed trajectory target location. In this situation, the following vehicle identifies both hazards 600 and 602 and once it determines hazard 602 has passed, it takes an evasive maneuver to avoid hazard 600 as shown by the solid line.

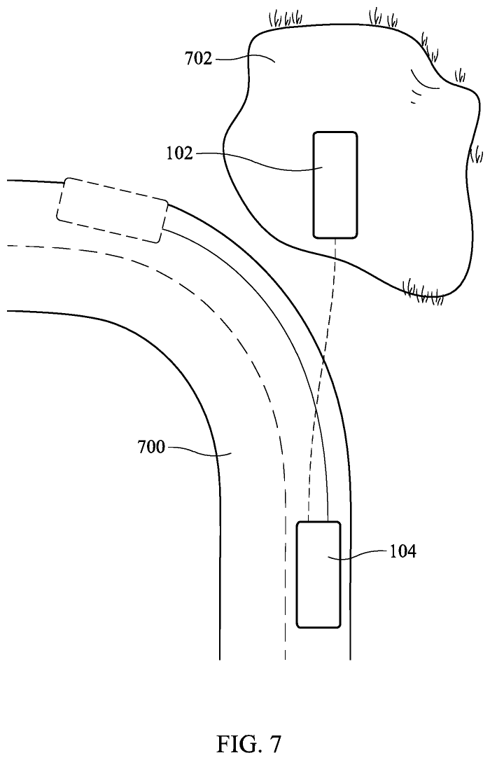

In FIG. 7, a partial block diagram of a pair of vehicles implementing an embodiment of the invention is depicted. Lead vehicle 102 and follow vehicle 104 are depicted on surface 700. Lead vehicle 102 is depicted in front of follow vehicle 104. While not shown here, lead vehicle 102 and follow vehicle 104 may include all the components as described in connection with FIG. 1. As shown here, the lead vehicle 104 has gone off the road 700 and has driven into a ravine 702. The dashed line indicates the trajectory target location of the follow vehicle 104. But, the follow vehicle 104 has determined that it cannot follow to the trajectory target location and avoid the hazard 702. Accordingly, the follow vehicle 104 determines it must initial a halt operation to safely stop. The solid line indicates that actual path followed by the follow vehicle 104 in performing the halt operation.

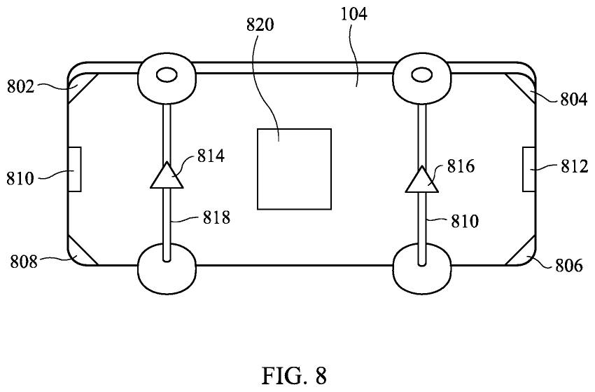

In FIG. 8, a simplified block diagram of an unmanned, selfpowered follow vehicle is depicted. In an embodiment, sensors 130 may include cameras 802-808 sensing each corner of the vehicle and where necessary midway points along the sides (not shown), which will enable a full 360 view of the road and surrounding area. Radar and lidar sensors 810 and 812, or the like, may be equipped near the front and rear to enable spatial data gathering including vehicles and hazards on all sides of the vehicle and above (ie. bridge clearances). The vehicle may be powered by electric motors 814, 816, one each axle 818, 820 with at least two steering axles (see below). Power 820 may be supplied by batteries, fuel cells, ICE or a combination thereof. It is important to note that embodiments of the invention are not limited to the configuration depicted in FIG. 8. The follow vehicle 104 may take on numerous component configurations as needed to implement the methods and systems disclosed herein.

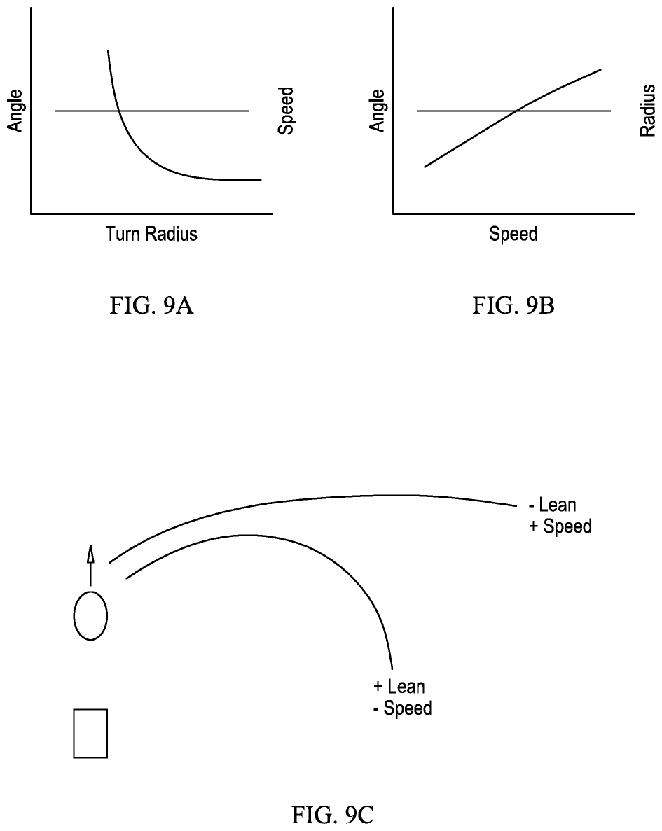

With reference to FIGS. 9a-9c, there are nearly limitless uses for the lead vehicle if it includes throttle, brake and steering. One use case which does not apply are motorcycles. Where a motorcycle is used as the lead vehicle, it must be equipped to send throttle, brake and lean angle. Lean angle is used to calculate steering output by determining the radius of the turn in order to identify the primary output location. The higher the lean angle for a given speed, the lower the turning radius and tighter the turn. Inversely lean angle must increase with speed to attain a desired turning radius. Where the lead motorcycle outputs higher speed and lower lean angle, the turning radius will be high and produce a shallow turn. Where the lead motorcycle outputs a higher lean angle and lower speed, the turning radius will be low and produce a tight turn. Secondary data assessment does not change with a motorcycle as lead vehicle.

While the invention has been particularly shown and described with respect to the illustrated embodiments thereof, it will be understood by those skilled in the art that the foregoing and other changes in form and details may be made therein without departing from the spirit and scope of the invention.

What is claimed is:

1. A method for controlling an unmanned follow vehicle following a lead vehicle, the method comprising:
receiving, by the follow vehicle comprising a processor, guidance information wirelessly transmitted to the follow vehicle from the lead vehicle, wherein the guidance information reflects current lead vehicle driving operation being performed by the lead vehicle;
determining, by the follow vehicle, a trajectory target location at least based in part on the guidance information received from the lead vehicle;
determining, by the follow vehicle, follow vehicle control instructions to control the follow vehicle driving operations to cause the follow vehicle to move to the trajectory target location;
comparing, by the follow vehicle, the follow vehicle control instructions with follow vehicle operational data to determine a conflict threshold between the follow vehicle control instructions and the follow vehicle operational data;
activating, by the follow vehicle, automatic control of the follow vehicle to the trajectory target location using the follow vehicle control instructions in response to the determined conflict threshold being below a setpoint that indicates the follow vehicle will not collide with a hazard in route to the trajectory target location.

2. The method of claim 1, further comprising:
identifying, by the follow vehicle, a hazard at least in part by using the follow vehicle operational data in response to the determined conflict threshold being above a setpoint that indicates the follow vehicle will collide with a hazard in route to the trajectory target location;
determining, by the follow vehicle, an avoidance trajectory target location based at least in part on the identified hazard, the follow vehicle operational data, and the trajectory target location;
determining, by the follow vehicle, follow vehicle avoidance control instructions to control the follow vehicle driving operations to cause the follow vehicle to move to the avoidance trajectory target location;
comparing, by the follow vehicle, the follow vehicle avoidance control instructions with follow vehicle operational data to determine a second conflict threshold between the follow vehicle avoidance control instructions and the follow vehicle operational data; and
activating, by the follow vehicle, automatic control of the follow vehicle to the avoidance trajectory target location using the follow vehicle avoidance control instructions in response to the determined second conflict threshold being below a setpoint that indicates the follow vehicle will not collide with the identified hazard or another hazard in route to the avoidance trajectory target location.

3. The method of claim 1, wherein guidance information includes steering position and acceleration/deceleration driving operation of the lead vehicle.

4. The method of claim 1, wherein follow vehicle operational data includes data captured from one or more sensors selected from the group consisting of radar, doppler radar, sonar, laser, optical, lidar, infrared, image sensor, accelerometer, and proximity sensor.

5. The method of claim 1, wherein follow vehicle operational data includes data captured from one or more data sources selected from the group consisting of GPS location data, map data, weather condition data, and road condition data.

6. The method of claim 1, wherein trajectory target location is determined such that the distance between the follow vehicle and the lead vehicle remains within a distance that guidance information can be received by the follow vehicle.

7. The method of claim 2, further comprising:
performing, by the follow vehicle, a halt operation to control the follow vehicle driving operations to cause the follow vehicle to brake and stop in response to the determined second conflict threshold remaining above the setpoint that indicates the follow vehicle will collide with a hazard in route to the avoidance trajectory target location.

8. A system for automatically controlling an unmanned follow vehicle following a lead vehicle, the system comprising:
a receiver configured to wirelessly receive guidance information from the lead vehicle regarding currently lead vehicle operations being performed by the lead vehicle;
a follow vehicle control unit configured to determine a trajectory target location at least based in part on the guidance information received from the lead vehicle, wherein the follow vehicle control unit determines follow vehicle control instructions to control the follow vehicle driving operations to cause the follow vehicle to move to the trajectory target location;
one or more sensors that detect follow vehicle operational data;
the follow vehicle control unit further configured to compare the follow vehicle control instructions with follow vehicle operational data to determine a conflict threshold between the follow vehicle control instructions and the follow vehicle operational data; and
a steering and powertrain control unit configured to apply the vehicle control instructions to cause the follow vehicle to move to the trajectory target location in response to the determined conflict threshold being below a setpoint that indicates the follow vehicle will not collide with a hazard in route to the trajectory target location.

9. The system of claim 8, wherein the follow vehicle control unit is further configured to identify a hazard at least in part by applying the follow vehicle operational data in response to the determined conflict threshold being above a setpoint that indicates the follow vehicle will collide with a hazard in route to the trajectory target location.

10. The system of claim 9, wherein the follow vehicle control unit is further configured to determine an avoidance trajectory target location based at least in part on the identified hazard, the follow vehicle operational data, and the trajectory target location, and determine follow vehicle avoidance control instructions to control the follow vehicle driving operations to cause the follow vehicle to move to the avoidance trajectory target location.

11. The system of claim 10, wherein the follow vehicle control unit is further configured to compare the follow vehicle avoidance control instructions with follow vehicle operational data to determine a second conflict threshold between the follow vehicle avoidance control instructions and the follow vehicle operational data; and wherein the steering and powertrain control unit configured to apply the vehicle avoidance control instructions to cause the follow vehicle to move to the avoidance trajectory target location in response to the determined second conflict threshold being below a setpoint that indicates the follow vehicle will not collide with a hazard in route to the avoidance trajectory target location.

12. The system of claim 11, the steering and powertrain control unit configured to apply halt instructions to cause the follow vehicle to brake and stop in response to the determined second conflict threshold remaining above the setpoint that indicates the follow vehicle will collide with a hazard in route to the avoidance trajectory target location.

13. The system of claim 8, wherein guidance information includes steering position and acceleration/deceleration driving operation of the lead vehicle.

14. The system of claim 8, wherein follow vehicle operational data includes data captured from one or more sensors selected from the group consisting of radar, doppler radar, sonar, laser, optical, lidar, infrared, image sensor, and proximity sensor.

15. The system of claim 8, wherein follow vehicle operational data includes data captured from one or more data sources selected from the group consisting of GPS location data, map data, weather condition data, and road condition data.
